(19) United States
(12) Patent Application Publication
(10) Pub. No.: US 2014/0184438 A1
(43) Pub. Date: Jul. 3, 2014

(54) TRANSMIT/RECEIVE MODULE FOR RADAR AND ASSEMBLING METHOD THEREOF

(71) Applicant: Electronics and Telecommunications Research Institute, Daejeon (KR)

(72) Inventors: Dong Pil Chang, Daejeon (KR); In Bok Yom, Daejeon (KR); Youn Sub Noh, Daejeon (KR); Jin Cheol Jeong, Daejeon (KR); Hong Gu Ji, Daejeon (KR); Man Seok Uhm, Daejeon (KR)

(73) Assignee: Electronics and Telecommunications Research Institute, Daejeon (KR)

(21) Appl. No.: 14/139,221

(22) Filed: Dec. 23, 2013

(30) Foreign Application Priority Data
Dec. 27, 2012 (KR) 10-2012-0154072

(51) Int. Cl. G01S 13/02

(52) U.S. Cl. CPC G01S 13/02
USPC 342/175

(57) ABSTRACT

A transmit/receive module for radar may include a radio frequency (RF) circuit unit including an RF substrate and an RF part; and a direct current (DC) power supply circuit unit including a printed circuit board (PCB) and a DC power supply circuit part. The RF circuit unit and the DC power supply circuit unit may be disposed so that a rear surface of the RF circuit unit faces a rear surface of the DC power supply circuit unit, and may be assembled to have a separate space using at least one separation wall.

### CROSS-REFERENCE TO RELATED APPLICATION

This application claims the priority benefit of Korean Patent Application No. 10-2012-0154072, filed on Dec. 27, 2012, in the Korean Intellectual Property Office, the disclosure of which is incorporated herein by reference.

### BACKGROUND

1. Field of the Invention

The present invention relates to a transmit/receive module for radar and an assembling method thereof, and more particularly, to a technology of disposing a radio frequency (RF) circuit unit and a direct current (DC) power supply circuit unit so that a rear surface of the RF circuit unit faces a rear surface of the DC power supply circuit unit, and assembling the RF circuit unit and the DC power supply circuit to have a separate space using at least one separation wall.

2. Description of the Related Art

A technology of assembling a transmit/receive module for radar refers to a technology of assembling a radio frequency (RF) circuit unit and a direct current (DC) power supply circuit unit. In the transmit/receive module for radar, the RF circuit unit and the DC power supply circuit unit may be assembled to have the same space.

### SUMMARY

Embodiments of the present invention provide a method, apparatus, and system that may dispose a radio frequency (RF) circuit unit and a direct current (DC) power supply circuit unit so that a rear surface of the RF circuit unit faces a rear surface of the DC power supply circuit unit, and may assemble the RF circuit unit and the DC power supply circuit to have a separate space.

Embodiments of the present invention also provide a method, apparatus, and system that may miniaturize a size of a transmit/receive module for radar by assembling an RF circuit unit and a DC power supply circuit unit to have a separate space.

Embodiments of the present invention also provide a method, apparatus, and system that may decrease unstableness by a pulse modulation signal or external power of a transmit/receive module for radar by assembling an RF circuit unit and a DC power supply circuit unit to have a separate space.

According to an aspect of the present invention, there is provided a transmit/receive module for radar, the module including: an RF circuit unit including an RF substrate and an RF part; and a DC power circuit unit including a printed circuit board (PCB) and a DC power supply circuit part. The RF circuit unit and the DC power supply circuit unit may be disposed so that a rear surface of the RF circuit unit faces a rear surface of the DC power supply circuit unit, and may be assembled to have a separate space using at least one separation wall.

The DC power circuit unit may be connected to the RF circuit unit using a feed-through capacitor having an electromagnetic interface (EMI) filter function, to supply power to the RF circuit unit.

A double-faced power circuit PCB technology may be applied to the PCB.

The DC power supply circuit part may include at least one of a switching field-effect transistor (FET), a driver integrated circuit (IC), and a buffer IC.

A single-layer RF substrate technology may be applied to the RF substrate.

On the RF substrate, each of a transmission line and a power connection line for connection between RF parts may be configured as a piece or may be configured as a single substrate.

The RF part may include at least one of a circulator, a high power amplifier monolithic microwave integrated circuit (MMIC), a low noise amplifier MMIC, and a multifunctional circuit MMIC.

According to another aspect of the present invention, there is provided a method of assembling a transmit/receive module for radar, the method including: disposing an RF circuit unit and a DC power supply circuit unit so that a rear surface of the RF circuit unit faces a rear surface of the DC power supply circuit unit; and assembling the RF circuit unit and the DC power supply circuit unit to have a separate space using at least one separation wall. The RF circuit unit may include an RF substrate and an RF part, and the DC power supply circuit unit may include a PCB and a DC power supply circuit part.

The assembling may include connecting the DC power circuit unit and the RF circuit unit using a feed-through capacitor having an EMI filter function, to supply power from the DC power supply circuit unit to the RF circuit unit.

The method of assembling a transmit/receive module for radar may further include applying a double-faced power supply circuit PCB technology to the PCB.

The method of assembling a transmit/receive module for radar may further include applying a single-layer RF substrate technology to the RF substrate.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a view illustrating a transmit/receive module for radar according to a related art;

FIG. 2 is a perspective view illustrating a radio frequency (RF) circuit unit in a transmit/receive module for radar according to an embodiment of the present invention;

FIG. 3 is a perspective view illustrating a direct current (DC) power supply circuit unit in a transmit/receive module for radar according to an embodiment of the present invention;

FIG. 4 is a perspective view illustrating a transmit/receive module for radar according to an embodiment of the present invention;

FIG. 5 is a flowchart illustrating a method of assembling a transmit/receive module for radar according to an embodiment of the present invention; and

FIG. 6 is a block diagram illustrating a transmit/receive module for radar according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

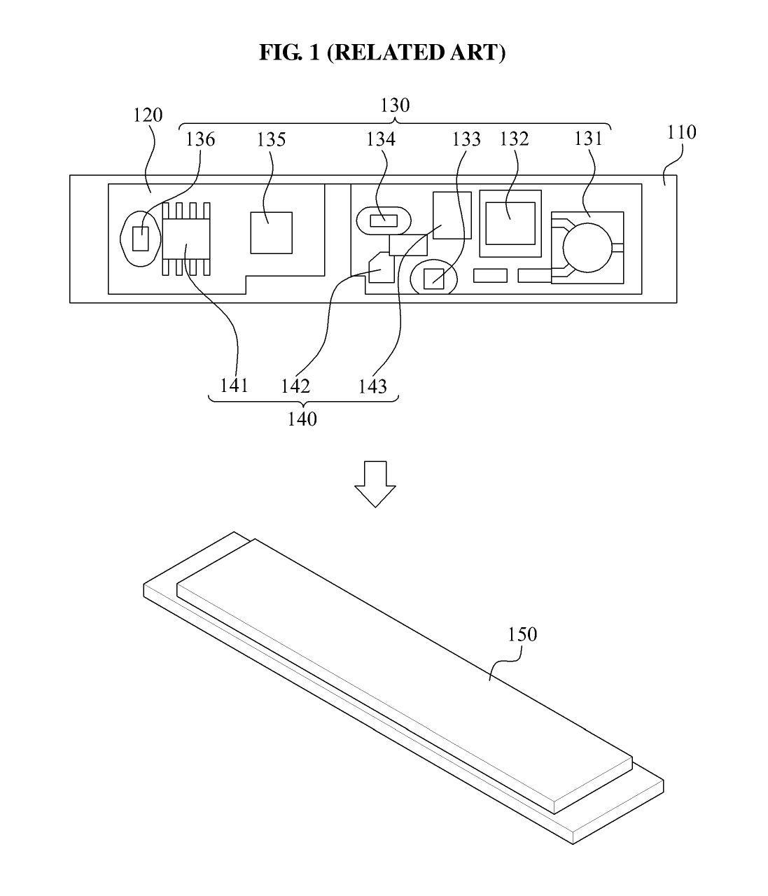

FIG. 1 is a view illustrating a transmit/receive module 150 for radar according to a related art.

Referring to FIG. 1, the transmit/receive module 150 for radar according to the related art includes a structure carrier 110, a multilayer radio frequency (RF) substrate 120 disposed on the structure carrier 110 as a low temperature co-fired ceramic (LTCC) substrate and to which a multilayer RF substrate technology is applied, RF parts 130, and power supply circuit parts 140.

Here, the RF parts 130 may be attached on the structure carrier 110 using a receiving hole that is formed to pass through the multilayer RF substrate 120. Also, the RF parts 130 may include a circulator 131, a high power amplifier monolithic microwave integrated circuit (MMIC) 132, a multifunctional circuit MMIC 133, a driving amplifier MMIC 134, a low noise amplifier MMIC 135, and a switch MMIC 136. Here, the RF parts 130 may be included in a RF circuit unit.

The power supply circuit parts 140 may be attached on the multilayer RF substrate 120. Here, the power supply circuit parts 140 may include a buffer IC 141, a driver IC 142, and a switching field-effect transistor (FET) 143. The power supply circuit parts 140 may indicate a DC power supply circuit unit.

As described above, the transmit/receive module 150 is assembled to be in a long two-dimensional (2D) structure so that the RF parts 130 and the power supply circuit parts 140 have the same space. Accordingly, resonance occurring around an operating frequency band of the transmit/receive module 150 and a noise signal occurring in the power supply circuit parts 140 may cause circuit resonance that directly flows in a path of an RF signal.

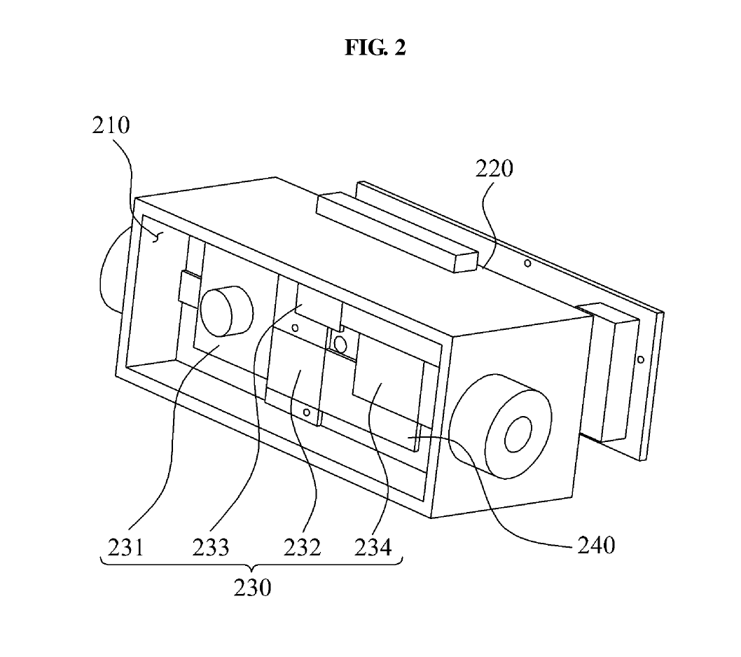

FIG. 2 is a perspective view illustrating an RF circuit unit in a transmit/receive module for radar according to an embodiment of the present invention.

Referring to FIG. 2, the RF circuit unit includes RF parts 230 and an RF substrate 240.

Here, the RF circuit unit may be disposed so that a rear surface of the RF circuit unit faces a rear surface of a DC power supply circuit unit 220, and may be assembled to have a space 210 separate from the DC power supply circuit unit 220 through at least one separation wall.

The RF parts 230 may include a circulator 231, a high power amplifier MMIC 232, a low noise amplifier MMIC 233, and a multifunctional circuit MMIC 234.

Also, a single-layer RF substrate technology may be applied to the RF substrate 240. On the RF substrate 240, each of a transmission line and a power supply connection line for connection between the RF parts 230 may be configured as a piece or may be configured as a single substrate.

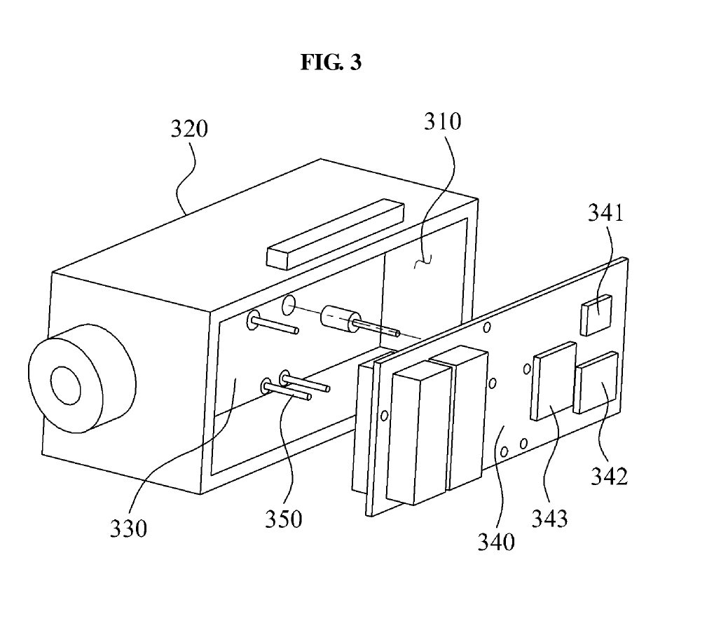

FIG. 3 is a perspective view illustrating a DC power supply circuit unit in a transmit/receive module for radar according to an embodiment of the present invention.

Referring to FIG. 3, the DC power supply circuit unit includes a PCB 340 and DC power supply circuit parts.

Here, the DC power supply circuit unit may be disposed so that a rear surface of an RF circuit unit 320 faces a rear surface of a DC power supply circuit unit, and may be assembled to have a space 310 separate from the DC power supply circuit unit through at least one separation wall 330. Also, the DC power supply circuit unit may be connected to the RF circuit unit 320 using a feed-through capacitor 350 having an electromagnetic interface (EMI) filter function, to supply DC power to the RF circuit unit 320.

The DC power supply circuit parts may include a buffer IC 341, a driver IC 342, and a switching FET 343.

A double-faced power supply circuit PCB technology may be applied to the PCB 340.

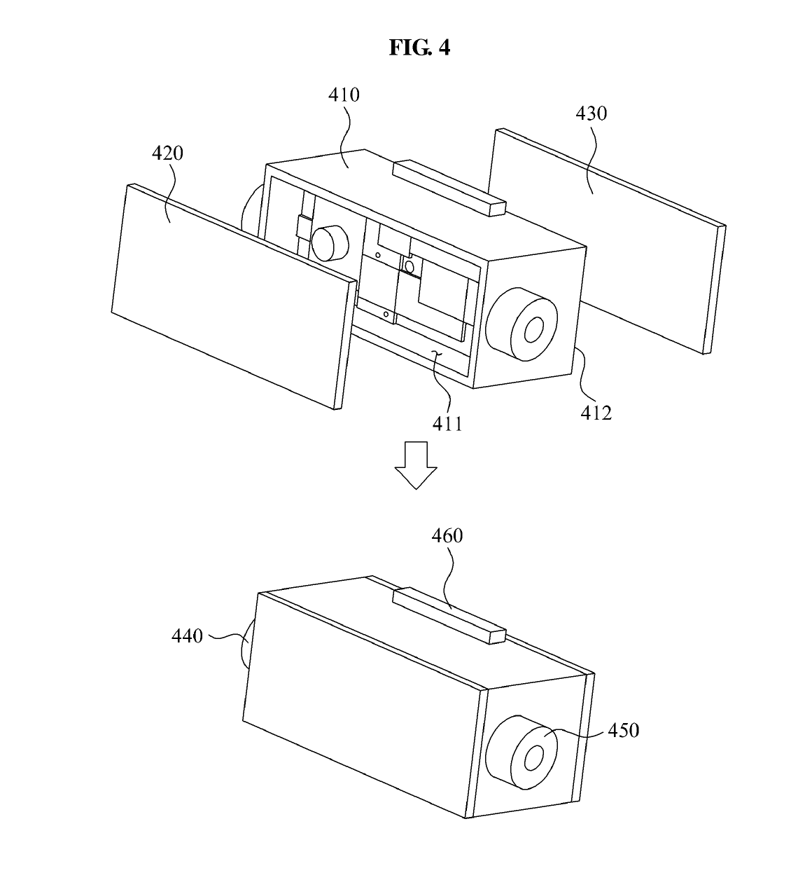

FIG. 4 is a perspective view illustrating a transmit/receive module for radar according to an embodiment of the present invention.

Referring to FIG. 4, the transmit/receive module may include a body 410, an RF circuit unit cover 420, and a DC power supply circuit unit cover 430. Here, the body 410 may be disposed so that a rear surface of an RF circuit unit 411 faces a rear surface of a DC power supply circuit unit 412, and may be assembled to have a separate space using at least one separation wall.

The transmit/receive module for radar in which the RF circuit unit cover 420 and the DC power supply circuit unit cover 430 are assembled to the body 410 may include an antenna connection connector 440, a common RF input/output connector 450, and a DC power supply and control signal connector 460.

As described above, in the transmit/receive module for radar, the RF circuit unit 411 and the DC power supply circuit unit 412 may be dispose so that the rear surface of the RF circuit unit 411 faces the rear surface of the DC power supply circuit unit 412, and may be assumed in a three-dimensional (3D) structure to have a separate space using at least one separation wall. Accordingly, it is possible to achieve a miniaturization and a decrease in unstableness by a pulse modulation signal or external power.

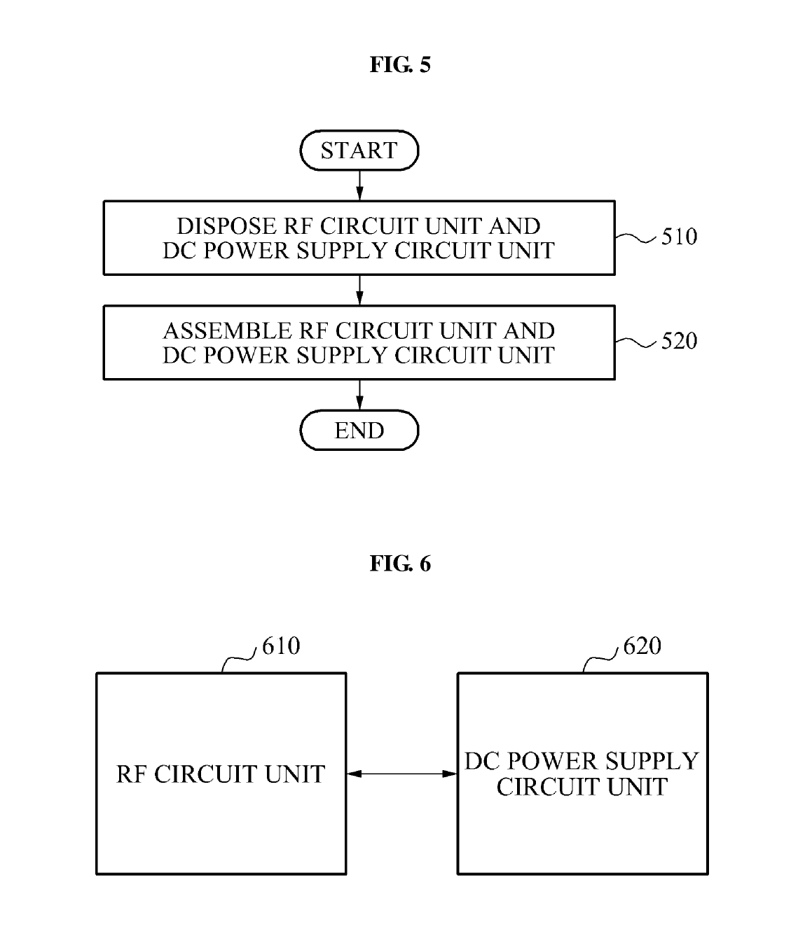

FIG. 5 is a flowchart illustrating a method of assembling a transmit/receive module for radar according to an embodiment of the present invention.

Referring to FIG. 5, in operation 510, an RF circuit unit and a DC power supply circuit unit are disposed so that a rear surface of the RF circuit unit faces a rear surface of the DC power supply circuit unit.

In operation 520, the RF circuit unit and the DC power supply circuit unit are assembled to have a separate space using at least one separation wall.

Here, the method of assembling a transmit/receive module for radar may connect the DC power supply circuit unit to the RF circuit unit using a feed-through capacitor having an EMI filter function, to supply DC power from the DC power circuit unit to the RF circuit unit.

Also, the method of assembling a transmit/receive module for radar may include a process of applying a double-faced power supply circuit PCB technology to a PCB.

Also, the method of assembling a transmit/receive module for radar may include a process of applying a single-layer RF substrate technology to an RF substrate.

FIG. 6 is a block diagram illustrating a transmit/receive module for radar according to an embodiment of the present invention.

Referring to FIG. 6, the transmit/receive module for radar may include an RF circuit unit 610 and a DC power supply circuit unit 620.

The RF circuit unit 610 may include an RF substrate and an RF part.

The DC power supply circuit unit 620 may include a PCB and a DC power supply circuit part.

Here, the RF circuit unit 610 and the DC power supply circuit unit 620 may be disposed so that a rear surface of the RF circuit unit 610 faces a rear surface of the DC power supply circuit unit 620, and may be assembled to have a separate space using at least one separation wall.

Also, the DC power supply circuit unit 620 may be connected to the RF circuit unit 610 using a feed-through capacitor having an EMI filter function, to supply DC power to the RF circuit unit 610.

According to embodiments of the present invention, there may be provided a method, apparatus, and system that may dispose an RF circuit unit and a DC power supply circuit unit so that a rear surface of the RF circuit unit faces a rear surface of the DC power supply circuit unit, and may assemble the RF circuit unit and the DC power supply circuit to have a separate space.

Also, according to embodiments of the present invention, there may be provided a method, apparatus, and system that may miniaturize a size of a transmit/receive module for radar by assembling an RF circuit unit and a DC power supply circuit unit to have a separate space.

Also, according to embodiments of the present invention, there may be provided a method, apparatus, and system that may decrease unstableness by a pulse modulation signal or external power of a transmit/receive module for radar by assembling an RF circuit unit and a DC power supply circuit unit to have a separate space.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A transmit/receive module for radar, the module comprising:
a radio frequency (RF) circuit unit including an RF substrate and an RF part; and
a direct current (DC) power supply circuit unit including a printed circuit board (PCB) and a DC power supply circuit part,
wherein the RF circuit unit and the DC power supply circuit unit are disposed so that a rear surface of the RF circuit unit faces a rear surface of the DC power supply circuit unit, and are assembled to have a separate space using at least one separation wall.

2. The module of claim 1, wherein the DC power supply circuit unit is connected to the RF circuit unit using a feed-through capacitor having an electromagnetic interface (EMI) filter function, to supply DC power to the RF circuit unit.

3. The module of claim 1, wherein a double-faced DC power supply circuit PCB technology is applied to the PCB.

4. The module of claim 1, wherein the DC power supply circuit part includes at least one of a switching field-effect transistor (FET), a driver integrated circuit (IC), and a buffer IC.

5. The module of claim 1, wherein a single-layer RF substrate technology is applied to the RF substrate.

6. The module of claim 1, wherein, on the RF substrate, each of a transmission line and a power supply connection line for connection between RF parts is configured as a piece or configured as a single substrate.

7. The module of claim 1, wherein the RF part includes at least one of a circulator, a high power amplifier monolithic microwave integrated circuit (MMIC), a low noise amplifier MMIC, and a multifunctional circuit MMIC.

8. A method of assembling a transmit/receive module for radar, the method comprising:
disposing a radio frequency (RF) circuit unit and a direct current (DC) power supply circuit unit so that a rear surface of the RF circuit unit faces a rear surface of the DC power supply circuit unit; and
assembling the RF circuit unit and the DC power supply circuit unit to have a separate space using at least one separation wall,
wherein the RF circuit unit includes an RF substrate and an RF part, and the DC power supply circuit unit includes a printed circuit board (PCB) and a DC power supply circuit part.

9. The method of claim 8, wherein the assembling comprises connecting the DC power supply circuit unit and the RF circuit unit using a feed-through capacitor having an electromagnetic interface (EMI) filter function, to supply DC power from the DC power supply circuit unit to the RF circuit unit.

10. The method of claim 8, further comprising:
applying a double-faced DC power supply circuit PCB technology to the PCB.

11. The method of claim 8, further comprising:
applying a single-layer RF substrate technology to the RF substrate.
